(19) United States
(12) Patent Application Publication
(10) Pub. No.: US 2008/0256842 A1
(43) Pub. Date: Oct. 23, 2008

(54) Animal trap

(76) Inventor: Behzad Vasseghi, Agoura Hills, CA (US)

Correspondence Address: SANDRA LEE LIPKIN;A LAW CORPORATION, 1891 GOODYEAR AVE., SUITE 622, VENTURA, CA, 93003, US

(21) Appl. No.: 11/788,472

(22) Filed: Apr. 20, 2007

(51) Int. Cl. A01M 23/08

(52) U.S. Cl. 43/65; 43/100

(57) ABSTRACT

An animal trap comprising a housing which is constructed of a sidewall that permits visual observation of the internal chamber enclosed by the sidewall of the housing. There is formed an entrance opening within the sidewall and mounted in conjunction with the entrance opening is a restrictor. The restrictor permits entry of an animal into the internal chamber but prevents exit of the animal from the internal chamber.

### BACKGROUND OF THE INVENTION

1. Field of the Invention

The field of this invention relates to a device that traps animals and more particularly to a device that is to trap an animal without causing injury or death to the animal.

2. Description of the Related Art

Animal traps have long been known. In the past, animals have been trapped for their furs and also because certain animals are nuisances. Common animals that are nuisances are mice, rats, gophers, ground squirrels, possums, and even coyotes. Also, a dog or a cat could be a nuisance animal in some instances. The subject matter of the present invention will be discussed primarily in relation to mice, but it is to be understood that it could be used in conjunction with other animals.

In some environments, mice can be a most undesirable problem. Mice can not only be unsanitary, but they are capable of causing destruction. In a home, an infestation of mice is exceedingly undesirable. On a farm, mice can infest certain areas, such as a grain silo and actually cause loss of income to the farmer.

In the past, there have been designed numerous types of mouse traps with the most common form of a mouse trap including a springable wire which is designed to come against the body of the mouse causing the mouse's death. When using of such traps, many people don't like to remove the mouse from the trap and reuse it. Therefore, the entire trap is disposed of along with the mouse. If one has a significant mouse problem and it happens to be that for every mouse caught there is a trap that is being disposed of, the overall cost for catching the mice can become significant.

There are two primary disadvantages to the prior art type of spring traps for catching mice. The first disadvantage is that it is only capable of catching one mouse at a time. To overcome this disadvantage, there are used a plurality of traps placed in a given area in order to possibly catch all the mice that have infested that area. This requires that the placer of the traps remember where each and every trap is placed. At times, the user of the traps may forget where a particular trap is placed, and if a mouse is caught by that trap, the mouse will deteriorate and can possibly cause a rather unsanitary condition.

The second disadvantage of the prior art spring trap for mice is that almost invariably the mice are killed. Some individuals prefer not to kill living creatures. Therefore, these individuals still desiring to rid themselves of an infestation of mice find it undesirable to use such a trap. For that end, it would be desirable to design some kind of a trap that would capture the mice in a live state. The mice are then to be disposed of at a remote location. It would also be desirable to design some form of a trap that permitted a plurality of mice to be captured at the same time rather than just capturing a single one.

### SUMMARY OF THE INVENTION

The basic embodiment of the present invention comprises an animal trap comprising a housing having a sidewall. The sidewall encloses an internal chamber. An entrance opening is formed in the sidewall with a restrictor being mounted in conjunction with this opening. The restrictor permits entry of an animal into the internal chamber but prevents exit of the animal from the internal chamber.

A further embodiment of the present invention is where the sidewall of the housing is constructed of a screening material.

A further embodiment of the present invention is where the basic embodiment is modified by the including of a handle on the housing with this housing permitting manual transporting of the housing to different locations.

A further embodiment of the present invention is where the basic embodiment is modified by the housing being of a dome shape.

A further embodiment of the present invention is where there is included a tray mounted in conjunction with the housing with the tray functioning to close the internal chamber or to be movable to open the internal chamber in order to remove a captured animal from the internal chamber.

A further embodiment of the present invention is where the just previous embodiment is modified by the tray being slidably movable relative to the housing.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is a top plan view of the basic embodiment of animal trap constructed in accordance with this invention;

FIG. 2 is a cross-sectional view through the animal trap of this invention taken along line 2-2 of FIG. 1;

FIG. 3 is a bottom view of the animal trap of the present invention taken along line 3-3 of FIG. 2;

FIG. 4 is a cross-sectional view through a portion of the tray of FIG. 3 taken along line 4-4 of FIG. 3;

### DETAILED DESCRIPTION OF THE INVENTION

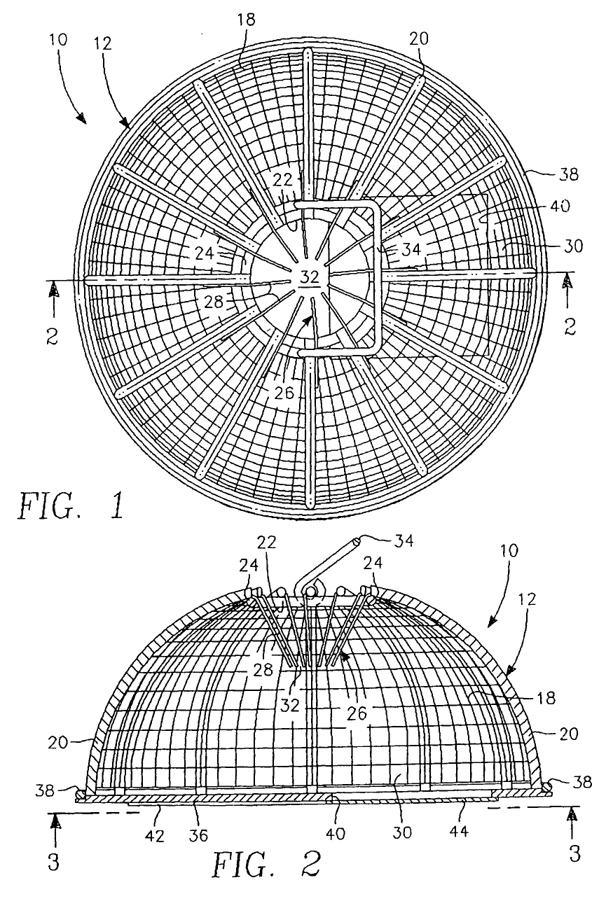

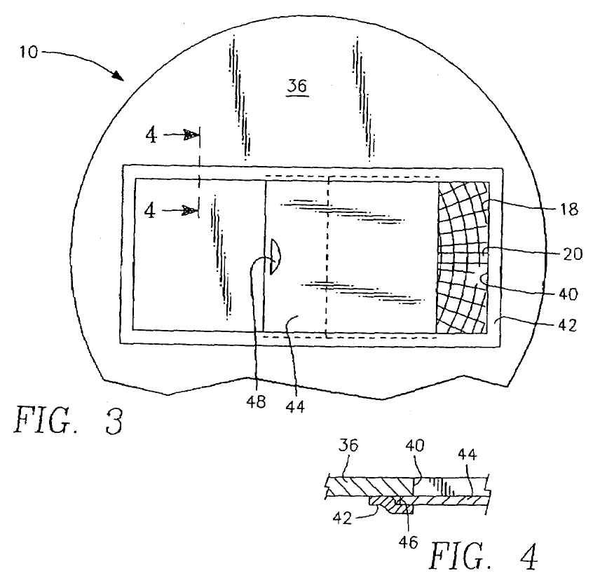

Referring particularly to the drawings, there is shown the basic embodiment of animal trap 10 of this invention. This basic embodiment is shown principally in FIGS. 1-3. This basic embodiment of animal trap 10 is constructed of a housing 12. The housing 12 is shown to be of a dome shape. However, other shapes could be utilized such as, for example, the truncated pyramid square shape housing 14 shown in FIGS. 5 and 6 and the truncated pyramid retangularly shaped housing 16 shown in FIG. 7. The housing 12 includes a sidewall 18 that is formed of a screening material. Typical screening material would be a wire screen. Other than screening material, a solid structure may be used. Also, although it is desirable to be able to visually observe that internal chamber 30, such is not a requirement. The sidewall 18 may or may not include arcuate shaped support rods 20 that are mounted in conjunction with the screening material of the sidewall 18 as such may not be necessary as the wire screen itself may provide sufficient strength. If the support rods 20 are used, the number of the support rods 20 could comprise any desirable number, not necessarily the twelve in number that are shown in FIGS. 1 and 2.

Formed within the sidewall 18 is an entrance opening 22. The entrance opening 22 is shown at the apex of the dome shaped sidewall but could be at any location. This entrance opening 22 may be formed by a support ring 24 that is located about the entrance opening 22. The support ring 24 is fixedly secured as by welding to the support rods 20 and also to the screening material of the sidewall 18. Typically, the support rods 20 will be constructed of a metallic material.

Mounted in conjunction with the entrance opening 22 is a restrictor 26. The restrictor 26 can take any of numerous forms, but the most desirable form for the restrictor 26 is that it comprises a plurality of wire members 28 (such as twelve in number) that are arranged in a truncated cone shaped pattern. The wire members 28 are fixedly secured to the sidewall 18 and are bent and extend past the support ring into the internal chamber 30 which is enclosed by the sidewall 18. The wire members 28 are sufficiently rigid but still are flexible and are capable of deflecting. The free end of the wire members 28 define an access opening 32. An animal, such as a mouse or a rat, is to be able to readily climb on the exterior surface of the sidewall 18 and slip through the entrance opening 22 sliding past the wire members 28 of the restrictor 26 and passing through the access opening 32 to then become confined within the internal chamber 30. Once the animal is captured within the internal chamber 30, it is not able to conduct itself back through the access opening 32 to gain its freedom exteriorly of the animal trap 10.

In order to achieve portability and transportability of the animal trap 10, there is mounted a handle 34 on the sidewall 18. The handle 34 is movable between a lower position lying against the sidewall 18 to an upper position located substantially transverse to the sidewall 18. The handle 34 is to be graspable to permit the transporting or portability.

Fixedly secured to the sidewall 18 substantially closing the internal chamber 30 is a tray 36. Tray 36 comprises a solid member which is fixedly secured as by wire ring 38 to the sidewall 18. The tray 36 typically will comprise a metallic sheet metal material. Formed within the tray 36 is an exit opening 40. Mounted on the tray 36 in the area directly adjacent the exit opening 40 is a slider flange 42. The slider flange 42 forms a slot 46. A door 44, which comprises a thin sheet material member, is mounted in conjunction with the slot 46. The door 46 includes a handle 48. The handle 48 is to be used to facilitate manual movement of the door 44 from a closed position closing of the exit opening 40 to an opening position to permit exit of any animal contained within the internal chamber 30. It is to be understood that they tray 36 and door 44 could be in many other forms all of which will permit emptying of the contents of the internal chamber 30.

What is claimed is:

1. An animal trap comprising:
a housing having a sidewall, said housing having an internal chamber; and
an entrance opening formed in said sidewall, a restrictor mounted in conjunction with said opening, said restrictor permitting entry of an animal into said internal chamber and preventing exit of the animal from said internal chamber, whereby an animal can enter said internal chamber and be captured.

2. The animal trap as defined in claim 1 wherein:
said sidewall permitting visual observation of said internal chamber from a location exterior of said housing.

3. The animal trap as defined in claim 2 wherein;
said sidewall being formed of a screening material.

4. The animal trap as defined in claim 1 wherein:
a handle being mounted on said housing, said handle to facilitate manual grasping and transporting of said housing.

5. The animal trap as defined in claim 1 wherein:
said housing being of a dome shape.

6. The animal trap as defined in claim 1 including:
a tray attached to said housing, said tray forming a bottom for said internal chamber where said tray is mounted furthest from said restrictor, said tray being movable between a closed position and an open position, said closed position closes said internal chamber, said open position permits access into said internal chamber and is to permit removal of any animal that is captured within said internal chamber when in said open position.

7. The animal trap as defined in claim 6 wherein:
said tray being slidingly movable relative to said housing.
